(19) United States
(12) Patent Application Publication
(10) Pub. No.: US 2009/0219491 A1
(43) Pub. Date: Sep. 3, 2009

(54) Method of combining multiple Gaussian beams for efficient uniform illumination of one-dimensional light modulators

(75) Inventors: Forrest Williams, Sandy, UT (US); Robert Christensen, Rapid City, SD (US); David M. Bloom, Jackson, WY (US); Allen Tanner, Sandy, UT (US)

Correspondence Address: GRANT R CLAYTON;CLAYTON HOWARTH & CANNON, PC, P O BOX 1909, SANDY, UT, 84091-1909, US

(73) Assignee: Evans & Sutherland Computer Corporation, Salt Lake City, UT (US)

(21) Appl. No.: 12/288,577

(22) Filed: Oct. 20, 2008

Related U.S. Application Data
(60) Provisional application No. 60/999,622, filed on Oct. 18, 2007.

(51) Int. Cl. G03B 21/28; G02B 26/00; H01S 3/00

(52) U.S. Cl. 353/37; 359/290; 362/553

(57) ABSTRACT

An illumination system for transforming at least one laser light beam having a non-uniform distribution in a first axis and a second axis to a beam having a substantially uniform distribution in the first axis while preserving the non-uniform distribution in the second axis. The transformed beam may be imaged as a line image onto a one-dimensional light modulation device. The illumination system may comprise a light tunnel having two sides that interact with the at least one laser light beam in the first axis and two sides that do not interact with the light in the second axis.

### CROSS-REFERENCE TO RELATED APPLICATIONS

This application claims the benefit of U.S. Provisional Application No. 60/999,622 filed Oct. 18, 2007, which is hereby incorporated by reference herein in its entirety, including but not limited to those portions that specifically appear hereinafter, this incorporation by reference being made with the following exception: In the event that any portion of the above-referenced provisional application is inconsistent with this application, this application supersedes said above-referenced provisional application.

### STATEMENT REGARDING FEDERALLY SPONSORED RESEARCH OR DEVELOPMENT

Not Applicable.

### BACKGROUND

1. The Field of the Invention.

The present disclosure relates generally to visual display devices, and more particularly, but not entirely, to illumination systems for use with display systems and other systems requiring illumination.

2. Description of Related Art

Display devices, such as televisions and image projectors, are increasingly using light modulators employing micro-electro-mechanical (“MEMS”) technology. MEMS-based light modulators are currently available in one-dimensional and two-dimensional varieties. Texas Instruments, for example, introduced a MEMS integrated circuit chip having a two-dimensional array formed from millions of tiny MEMS mirrors disposed on a substrate. Each mirror corresponds to a pixel in an image and electronic signals in the chip cause the mirrors to move and reflect light in different directions to form bright or dark pixels. See, for example, U.S. Pat. No. 4,710,732, which is hereby incorporated herein by this reference. One-dimensional light modulators, typically comprising a linear array of MEMS light modulating structures, may also be used to form a two-dimensional image through the use of appropriate magnifying optics and scanning mirrors. See for example, U.S. Pat. Nos. 5,982,553 and 7,054,051, which are hereby incorporated herein by this reference.

Both one-dimensional and two-dimensional light modulators require a light source to illuminate their light modulating surfaces. In order to accurately display an image using a two-dimensional light modulator, the intensity of the illumination provided by the light source should be uniform across its two-dimensional array of light modulating elements so that the generated pixels on a viewing surface are evenly illuminated. The illumination requirements for a one-dimensional light modulator may be slightly different from that of a two-dimensional light modulator. In particular, it has been found that the best images are formed on a viewing surface when the illumination of the light modulating elements of the one-dimensional light modulator is uniform along a first axis and non-uniform, such as Gaussian, along a second axis.

Halogen incandescent bulbs have been used in the past as light sources for at least two-dimensional light modulators. While halogen bulbs will produce a significant lumen output, they are known to be extremely inefficient in terms of converting electrical power to visible light. Further, due to their inherent inefficiency, halogen bulbs produce excessive heat, which requires the engineering of complex heat removal systems to prevent heat damage to surrounding components. Disadvantageously, halogen bulbs also have a relatively short life span and require frequent replacement. Halogen bulbs have, however, proven unsuitable for use with one-dimensional light modulators.

Coherent light sources, such as lasers, have been used in the past as light sources for illuminating one-dimensional light modulators. But, even coherent light sources also have their drawbacks. For example, achieving high amounts of lumen output from coherent light sources may require large and expensive amplification systems. Further, light beams emitted from coherent light sources typically have a non-uniform intensity distribution, such as a Gaussian distribution, that are generally unsuitable for use with light modulators.

In the past, one well-known method for converting a laser beam having a non-uniform distribution into a beam having a uniform, or top-hat distribution, was accomplished by employing a special type of lens, known as a Powell lens. In fact, Powell lenses are widely known to produce an efficient line pattern that overcomes the limits of Gaussian patterns.

Recent advances in the development of diode lasers have attempted to address the need for expensive amplifiers with coherent light sources. However, while more energy efficient, an individual diode laser does not have sufficient output for use with most image projection systems. To overcome this drawback, multiple diode lasers may be grouped together into an array. However, because of the spatial distribution inherent with diode-laser arrays, it is not always possible to use a single Powell lens in order to convert the Gaussian distributions of the beams emitted from a diode-laser array into a uniform, or top-hat, distribution. Another drawback to the use of a diode-laser array is that the differences in the output of each of the diode lasers may cause irregularities in the intensity of the spatial distribution.

One previous attempt to transform a non-uniform intensity distribution of a beam emitted from a laser into a beam with a uniform intensity distribution is disclosed in U.S. Pat. No. 4,744,615 (granted May 17, 1988 to Fan et al.). Fan et al. discloses directing a coherent laser beam having a non-uniform spatial intensity distribution into a light tunnel to thereby produce a beam having a substantially uniform spatial intensity distribution. The light tunnel of the Fan et al. device includes a polygonal cross-section such that the image produced at the exit of the light tunnel will have a substantially uniform intensity distribution in two-dimensions. While the Fan et al. device is suitable for its intended purpose of illuminating a mask for the fabrication of microcircuits as disclosed therein; it is not suitable for illuminating a one-dimensional light modulator. In particular, the Fan et al. device cannot generate a line image with a substantially uniform distribution along a first axis and a non-uniform distribution along a second axis, as is necessary for the most effective use of one-dimensional light modulators.

Thus, there exists a need for an optical system that is able to efficiently convert the non-uniform distribution of laser beams generated by a diode-laser array into a uniform distribution along a first axis and a non-uniform distribution along a second axis, especially when such diode-laser arrays are used to illuminate one-dimensional light modulators. The features and advantages of this disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The patent or application file contains at least one drawing executed in color. Copies of this patent or patent application publication with color drawing(s) will be provided by the Office upon request and upon payment of the necessary fee.

The features and advantages of the disclosure will become apparent from a consideration of the subsequent detailed description presented in connection with the accompanying drawings in which:

FIG. 1 is a diagram illustrating an optical system pursuant to an embodiment of the present disclosure;

FIG. 2 is a top view of a light modulation device illuminated with a line image produced by the optical system shown in FIG. 1;

FIG. 3 depicts a spatial intensity distribution in both the Y-axis and the X-axis of the line image produced by the optical system shown in FIG. 1;

FIG. 4 depicts a display system pursuant to an embodiment of the present invention; and

FIGS. 5A-5C depict a perspective view, a top view, and an end view, respectively, of a light tunnel.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. Further, as used herein, the terms “comprising,” “including,” “containing,” “having,” “characterized by,” and grammatical equivalents thereof are inclusive or open-ended terms that do not exclude additional, unrecited elements or method steps.

Applicants have discovered an illumination system for transforming an image generated by an array of coherent light sources with a non-uniform intensity distribution into an image having a uniform distribution, or top-hat distribution, along a first axis, and a non-uniform intensity distribution along a second axis. The present disclosure may be particularly adapted for use with one-dimensional light modulators that require a line image of light with a uniform intensity distribution over the long dimension of the array of light modulating elements on the light modulator.

The present disclosure may further preserve a Gaussian intensity distribution in an axis orthogonal to the long dimension of the one-dimensional array of light modulating elements on the light modulator. It will be appreciated by those having ordinary skill in the art that the preservation of the non-uniform, or Gaussian, intensity distribution along this orthogonal axis helps to achieve narrower line widths (i.e., improved image resolution in the orthogonal direction) since Gaussian beams focus to smaller spot sizes as compared to the spot sizes achieved with uniform-intensity beams. The present disclosure is further unique in that it may be aligned to maintain the polarization state of the original laser beams.

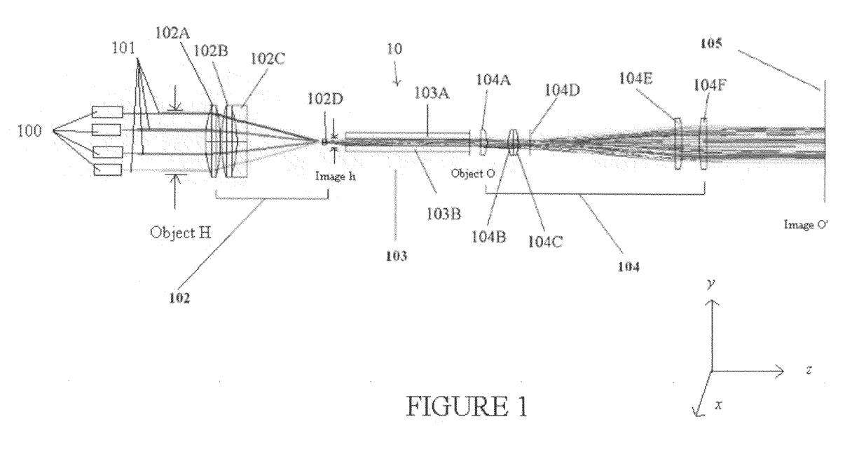

Referring now to FIG. 1, there is depicted an optical system, generally designated at 10, according to an embodiment of the present disclosure. The optical system 10 includes an array of light sources 100 that generate coherent beams of light 101. In an embodiment of the present disclosure, each of the light sources 100 is a semiconductor laser having an array of high-power surface emitting diode lasers disposed on a chip. It will be noted that the colors represented in FIG. 1 are not intended to represent any particular wavelength of beams of light 101, in fact the wavelengths of the beams of light 101 may all be the same (as explained below), but the colors represented in FIG. 1 are intended to clarify the function of the exemplary embodiment of the present disclosure.

Each of the light sources 100 may emit a light beam 101 that is the same wavelength as the light beams 101 emitted by the other light sources 100. That is, the light beams 101 may all be of the same color, such as red, green or blue. It will be appreciated that the light sources 100 may be grouped into an array to generate the necessary output suitable for use with the optical system 10. Each of the beams 101 may be generated from an array of diode emitters or just a single emitter.

Novalux, Inc. currently manufactures diode laser platforms suitable for use with the present disclosure. However, the present disclosure may be used with single laser beams such as those taught in U.S. Pat. No. 6,763,042, which is hereby incorporated by reference in its entirety. It should be further noted that the present disclosure may include only one of the light sources 100 and beams 101.

As mentioned, each of the beams 101 may be generated from one of the light sources 100. The beams 101 may each have a divergence a, which is not explicitly shown in FIG. 1, when emitted from their respective light sources 100. Each of the beams 101 may initially have a non-uniform intensity distribution. The non-uniform distribution of each of the beams 101 may consist of a circular Gaussian distribution.

In an embodiment of the present disclosure, reflective mirrors (not explicitly shown) may reduce the spatial distances and angular separations between the beams 101 emitted from the light sources 100. These mirrors may be operable to direct the beams 101 into a set of injector optics 102. It will be noted that the multiple beams 101 together form an apparent object with a height of H just prior to entering the set of injector optics 102. Furthermore, because the beams 101 are lasers, they may have a relatively small divergence a (typically, 0<α<0.01 radians, although much greater values of a are permissible).

The set of injector optics 102 may comprise lenses 102A, 102B, 102C and 102D. It will be appreciated that the overall purpose of the injector optics 102 may be to reduce the size of the object of height H formed by the beams 101 to a new image having a lesser height of h. Furthermore, the injector optics 102 may increase the divergence of the beams 101 from α to α′, which is also not explicitly shown in FIG. 1, prior to the beams 101 entering a light tunnel 103, with α′ increasing in direct proportion to the decrease in size from H to h.

In an embodiment of the present disclosure, the injector optics 102 may reduce the image size of the beams 101 between about 5 and about 50 times. In an embodiment of the present disclosure, the injector optics 102 may reduce the image size of the beams 101 between about 18 and about 22 times. In an embodiment of the present disclosure, the injector optics 102 may reduce the image size of the beams 101 approximately by about 20 times. That is,

$$\frac{H}{h} ≅ 20$$

The injector optics 102 may be collectively referred herein as an “optical reducer” since the injector optics 102 are operable to reduce the size of the apparent object of the beams 101.

At the same time the object height H is reduced to an image height h, the injector optics 102 increase the divergence α of the beams 101 to divergence α′. In an embodiment of the present disclosure, the divergence is increased between about 5 and about 50 times. In an embodiment of the present disclosure, the divergence is increased between about 18 and about 22 times. In another embodiment of the present disclosure, the divergence is increased between about 5 times to about 30 times. In yet another embodiment of the present disclosure, the divergence is increased about 20 times. That is,

α=20×α

Turning now to the optics 102A, 102B, 102C, and 102D, each will now be described pursuant to an embodiment of the present disclosure. Optic 102A may comprise a spherical or cylindrical optic having a clear aperture such that it can transmit all of the light from an object of height H. Optic 102B may comprise a spherical or cylindrical optic having a clear aperture such that it can transmit all of the light transmitted by optic 102A. Optic 102C may comprise a spherical or cylindrical optic having a clear aperture such that it can transmit all of the light transmitted through optics 102A and 102B. Optics 102A, 102B, and 102C may cause the beams 101 of apparent object size H to be collimated such that the chief rays of each of the beams 101 passes through a common focal point. In an embodiment of the present disclosure, the beams 101 are also collimated such that a common pupil is formed in the focal plane of the system consisting of optics 102A, 102B, and 102C.

In an embodiment of the present disclosure, the optic 102D may comprise a spherical or cylindrical optic having a different focal length than optics 102A, 102B, and 102C. The focal point of optic 102D may be placed at approximately the same position of the focal point of the system consisting of optics 102A, 102B, and 102C, wherein a reduction in size of the apparent object of height H formed by the beams 101 is reduced to an image having a height of h upon exiting the injector optics 102. The optic 102D now finishes the injection of the light beams 101 into the light tunnel 103. It will be appreciated by one having ordinary skill in the art that the divergence of the beams 101 in the system will increase by the same factor with which the height of the object is reduced as determined by the equation H/h.

The light tunnel 103 may comprise two opposing sides having walls 103A and 103B, respectively, and extend along a Z-axis. The walls 103A and 103B may be substantially parallel to each other and include a reflective coating on their inner surfaces. The walls 103A and 103B may be orthogonal to a Y-axis and parallel to an X-axis. The light tunnel 103 may have a hollow interior passageway with a light entrance at one end and a light exit at the other end. The walls 103A and 103B may extend from the light entrance to the light exit. In addition, the remaining two sides of the light tunnel 103, the sides orthogonal to the X-axis and parallel to the Y-axis, may be left open or constructed from a material that will not interact with light, such as clear glass or a material with a light absorbing capability.

The light tunnel 103 operates to convert the non-uniform distribution of the beams 101 into a beam with a uniform distribution along a Y-axis and a non-uniform distribution along an X-axis. This may be accomplished as the beams 101 are repeatedly reflected between the inner surfaces of the walls 103A and 103B. It will be appreciated by those having ordinary skill in the art that the greater the increase in divergence of the beams 101 as caused by the injector optics 102, the more numerous such multiple internal reflections are for a given propagation distance within the light tunnel 103. Further, without the increased divergence imparted to the beams 101 by the optics 102, or, without substantially increasing the length of the light tunnel 103, the light tunnel 103 would be less effective in converting the non-uniform distribution to a uniform distribution along the Y-axis of the beams 101.

Furthermore, the Gaussian profile of the beams 101 along their X-axis, which is orthogonal to the Y-axis, remains substantially unchanged by the light tunnel 103 due to the fact that the light tunnel 103 is constructed such that its width in the direction of the X-axis is always greater than that of the Gaussian distribution of the beams 101, so that the corresponding sides of the light tunnel 103 never interact with the beams 101 in the X-axis. For this reason, the sides of the light tunnel 103 adjacent the sides 103A and 103B may be left open or constructed from a material that does not interact with light, such as glass or a light absorbing material. In an embodiment of the present disclosure, sides parallel to the Y-axis are present on the light tunnel 103, but they do not interact meaningfully with the beams 101.

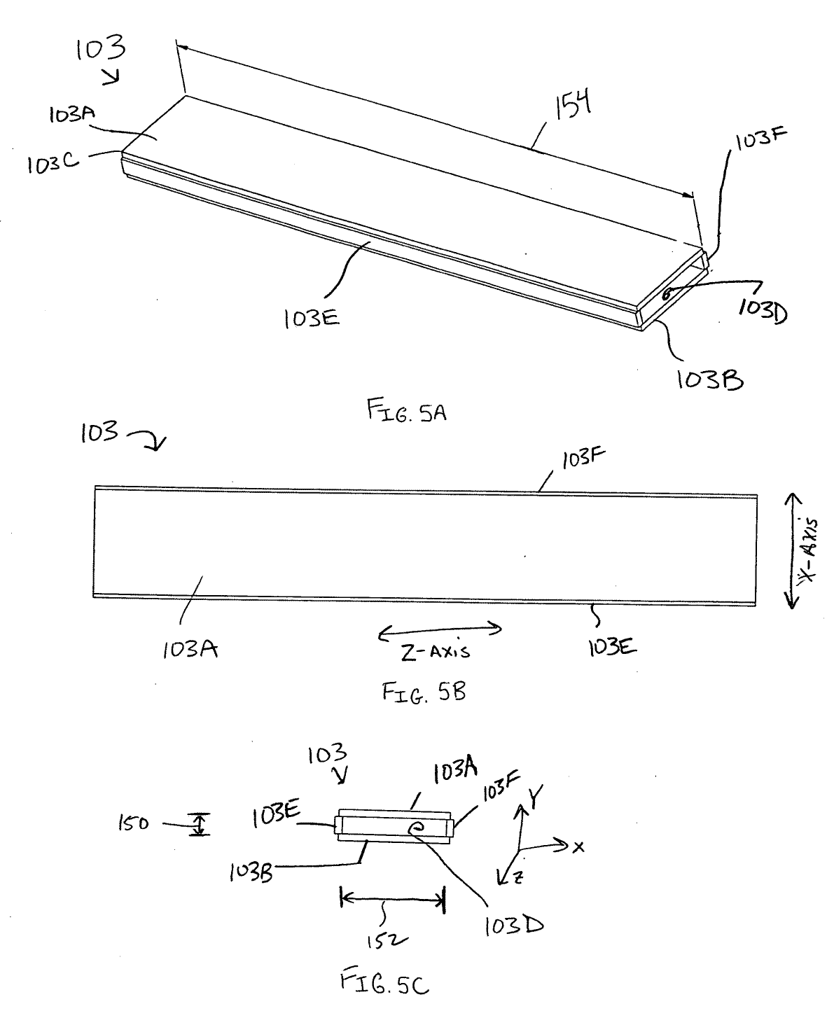

Referring now to FIGS. 5A-5C, there is depicted a more detailed view of the light tunnel 103 suitable for use with the system 10 depicted in FIG. 1. As previously discussed, the light tunnel 103 comprises opposing walls 103A and 103B extending from a light entrance 103C to a light exit 103D. As further previously described, the internal surfaces of the walls 103A and 103D may be reflective and form the sides of a light passageway through the light tunnel 103. Disposed between each of the walls 103A and 103B may be walls 103E and 103F. Walls 103E and 103F may be spaced apart to thereby form sides of the light passageway through the light tunnel 103. However, the internal surfaces of the walls 103E and 103F may not interact with light passing through the internal passageway of the light tunnel 103. In this regard, the walls 103E and 103F may be formed from glass, a light absorbing material, or any other material that will not cause or reduce internal reflections from the walls 103E and 103F.

In an embodiment of the present disclosure, the walls 103E and 103F may be omitted entirely and the sides of the internal passageway may be left open. It will be appreciated however, that even though the walls 103E and 103F do not interact with light passing through the light tunnel 103, that it is convenient to use walls 103E and 103F to maintain the proper spacing between, and to support the walls 103A and 103B.

Still referring to FIGS. 5A-5C, in another embodiment of the present disclosure, the internal passageway in the light tunnel 103 has a height, indicated by the reference numeral 150, of about 2.8 mm, a width, indicated by the reference numeral 152, sufficient such that there is no reflection from the beams in the X-axis (such as about between about 14 mm and about 20 mm, or greater), and a length, indicated with the reference numeral 154, of about 100 mm. It will be understood that the length of the walls 103A and 103B of the light tunnel 103 is relatively short because of the “fast” divergence of the beams 101 created by the injector optics 102 (see FIG. 1).

Referring now to FIGS. 1 and 5A-5C, in order to cause a relatively uniform image in the Y-axis suitable for use with a one-dimensional light modulator, each beam 101 may need to be internally reflected between the walls 103A and 103B (in the Y-axis) at least five (5) times in the light tunnel 103. More than five (5) reflections inside of the light tunnel 103 is typically not required to achieve a uniform distribution, i.e., the distribution is completely uniform within five (5) reflections as the beams 101 propagate through the tunnel 103. Increasing the divergence will cause the beams 101 to reflect more often, thereby causing the length of the light tunnel 103 needed to achieve a uniform distribution to be relatively short. If the divergence of the beams 101 were smaller or “slower,” the length of the light tunnel 103 would need to be increased. As mentioned, the light tunnel 103 need not have sides to reflect a beam in the X-axis and, therefore, the light tunnel 103 may consist of just two parallel mirrors.

It will be appreciated that other light-mixing devices can also be utilized with the present disclosure. For example, a light rod constructed of a transmissive material such as glass or plastic with similar dimensions may also be utilized. Thus, it will be appreciated that any light-mixing device operable to generate a uniform distribution from a non-uniform beam, such as a beam with a Gaussian distribution, falls within the scope of the present disclosure.

With sufficient length of the light tunnel 103 for a given divergence α′ of the beams 101, the output of the light tunnel will be uniform in intensity along an axis (hereafter referred to as the “Y-axis”) that is normal to both of the internal reflective surfaces of walls 103A and 103B. Thus, any faithful image of the output of the light tunnel 103 will also exhibit a uniform intensity distribution along this same Y-axis.

The light from each individual beam of beams 101 will be uniformly distributed along the Y-axis at the output of the light tunnel 103, so that any image of this output will cause light from each individual beam to be uniformly distributed over the entire image. Consequently, it is convenient to treat the output plane of the light tunnel 103 as an object O for the remaining optics 104 of the illumination system.

Referring now primarily to just FIG. 1, imaging optics, designated by the bracket 104, cause the apparent object O formed by the output plane of the light tunnel 103 to be magnified and telecentrically re-imaged along a surface 105 to form an image O′. In particular, imaging optics 104 image the object O having a height of approximately 2.8 mm in the Y-axis onto the surface 105 such that an image O′ is formed with a new height of approximately 31 mm (approximately the length of an active area of a light modulator). As mentioned, the new image O′ formed from the object O by the imaging optics 104 is a telecentric image.

Along the axis perpendicular to the Y-axis (hereafter referred to as the “X-axis”), the imaging optics 104 cause an image P, not explicitly shown in FIG. 1, to be focused into an image P′ at the surface 105 such that image P′ is contained in the same plane as image O′. Image P, however, is not co-located with the object O. Image P is located at the focal point of optic 102D where object O is located at end of the light tunnel 103.

Furthermore, it should be noted that, as drawn in FIG. 1, cylindrical optics may be used to form an image of O at O′ in the Y-axis, and that cylindrical optics may be used to form an image of the beam waists in the X-axis at O′ Thus, at O′, in the Y-axis there is an image of the output of the light tunnel 103 and in the X-axis there is an image of the beam waists. In other words, the optical system may be “anamorphic” wherein the focus in one axis may be different or nonexistent in the other axis.

Still referring primarily to FIG. 1, each of the individual components of the imaging optics 104 will now be described. Optic 104A may comprise a spherical or cylindrical lens for receiving the object O from the output end of light tunnel 103. Optics 104B and 104C work in conjunction with the rest of the optics in imaging optics 104 in order to re-image two different planes onto the same image surface 105. The line marked with the reference numeral 104D represents a pupil formed by the previous optics. Optics 104E and 104F are spherical or cylindrical optics that continue to work with the rest of the optics in the imaging optics 104 to form a telecentric magnified image of O, that is, O′ on the surface 105. The surface 105 may be disposed on, and be part of, a light-modulating device.

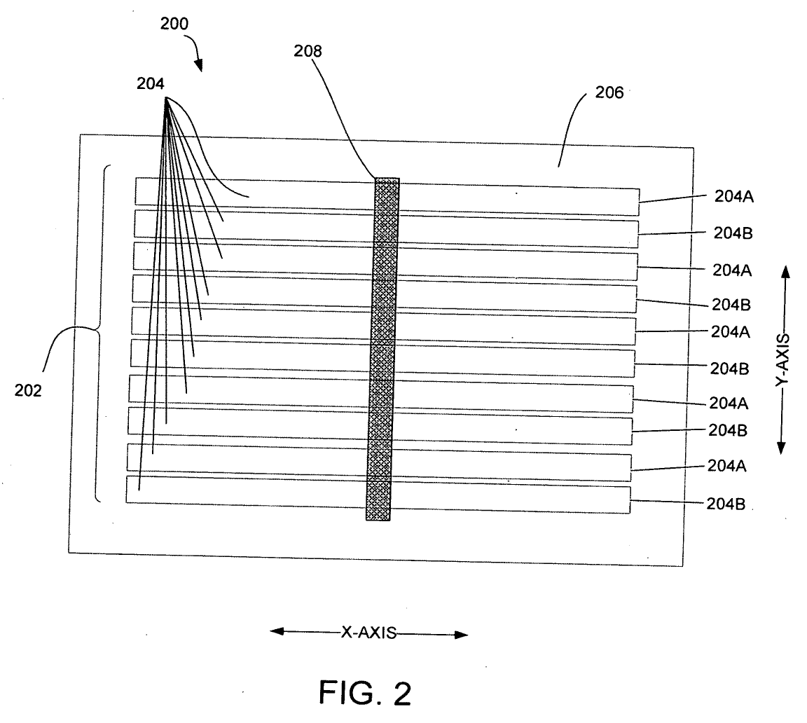

Referring now to FIG. 2, there is depicted a light-modulating device 200 suitable for use in conjunction with the system 10. The light-modulation device 200 may be a one-dimensional light modulator having a one-dimensional array 202 of light modulation elements arranged in a column along the Y-axis. In particular, the array 202 may comprise a plurality of reflective and deformable ribbons 204 suspended over a substrate 206 and extending in the direction of the X-axis. These ribbons 204 are arranged in a column of parallel rows and may be deflected, i.e., pulled down, by applying a bias voltage between the ribbons 204 and the substrate 206.

In an embodiment of the present disclosure, the light modulation device 200 may modulate light via diffraction. In particular, a first group of the ribbons 204 may comprise alternate rows of the ribbons. The ribbons 204 of the first group may be collectively driven by a single digital-to-analog controller (“DAC”) such that a common bias voltage may be applied to each of them at the same time. For this reason, the ribbons 204A of the first group are sometimes referred to as “bias ribbons.” A second group of ribbons 204 may comprise those alternate rows of ribbons 204 that are not part of the first group. Each of the ribbons 204B of the second group may be individually addressable or controllable by its own dedicated DAC device such that a variable bias voltage may be independently applied to each of them. For this reason, the ribbons 204 of the second group are sometimes referred to as “active ribbons.”

The bias and active ribbons may be sub-divided into separately controllable picture elements referred to herein as “pixel elements.” Each pixel element contains, at a minimum, a bias ribbon and an active ribbon. When the reflective surfaces of the bias and active ribbons of a pixel element are co-planar, incident light directed onto the pixel element is reflected. By blocking the reflected light from a pixel element, a dark spot is produced on the viewing surface at a corresponding display pixel. When the reflective surfaces of the bias and active ribbons of a pixel element are not co-planar, incident light may be both diffracted and reflected off of the pixel element. By separating the diffracted light from the reflected light, the diffracted light produces a bright spot on the corresponding display pixel.

The intensity of the light produced on the viewing surface by a given pixel element may be controlled by varying the separation between the reflective surfaces of its active and bias ribbons. Typically, this is accomplished by varying the voltage applied to the active ribbon while holding the bias ribbon at a common bias voltage. It has been previously determined that the maximum light intensity output for a pixel element may occur in a diffraction based system when the distance between the reflective surfaces its active and bias ribbons is λ/4, where λ is the wavelength of the light incident on the pixel element. The minimum light intensity output for a pixel element may occur when the reflective surfaces of its active and bias ribbons are co-planar. Intermediate light intensities may be output from the pixel element by varying the separation between the reflective surfaces of the active and bias ribbons between co-planar and λ/4.

It will be appreciated that although a limited number of ribbons 204 are depicted for the light modulation device 200 for purposes of convenience and clarity, that the light modulation device 200 may include a column of several hundred or thousand ribbons 204 extending along the Y-axis. In this manner, the ribbons 204 may form several hundred or thousand pixel elements. It will be further appreciated that the light modulation device 200 is best suited for display systems that employ a line-scan architecture. Display systems that employ a line-scan architecture typically scan an entire column, or row, of pixels across a viewing surface using a single scanning mirror.

Still referring to FIG. 2, in an embodiment of the present disclosure, the light modulation device 200 may modulate light using polarization in lieu of diffraction. In particular, the ribbons 204 may be operable to vary path lengths traveled by beams of light to thereby impart a phase shift between two beams of light when they are recombined. A polarization-based light modulator and system suitable for use with the present disclosure is described in U.S. Provisional Patent Application Nos. 61/095,917; 61/097,364; and 61/093,187; which are hereby incorporated by reference in their entireties. It will be further appreciated that the light modulation device 200 may include other MEMS elements, including cantilevers and the like, without departing from the scope of the present disclosure.

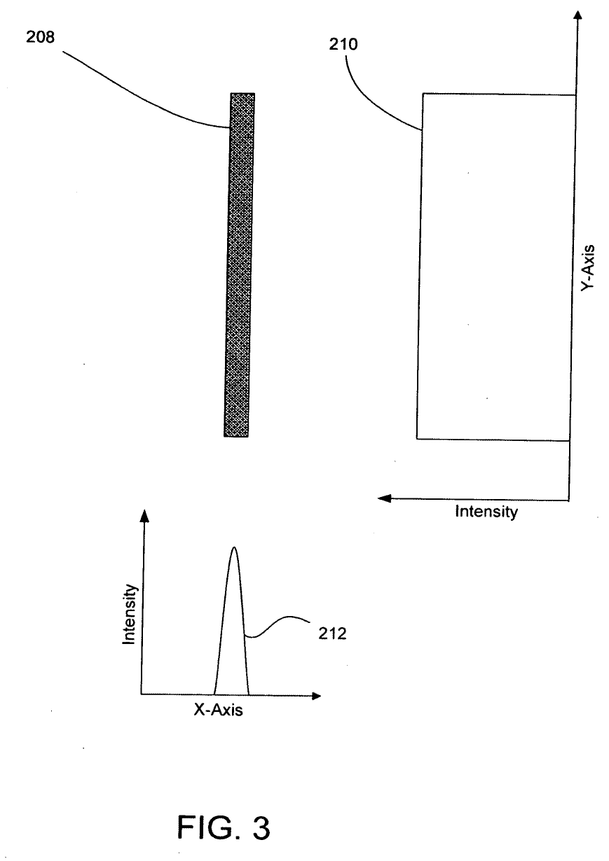

Still primarily referring to FIG. 2, a line image 208 may be formed on the ribbons 204 by the system 10 depicted in FIG. 1. The line image 208 formed by the system 10 may extend along the Y-axis such that a portion of each of the ribbons 204 is evenly illuminated. In particular, as shown in FIG. 3, a graph representing a spatial intensity distribution 210 along the Y-axis of the line image 208 is depicted as well as a graph representing a spatial intensity distribution 212 along the X-axis of the line image 208. As may be observed, the spatial intensity distribution 210 of the line image 208 along the Y-axis comprises a uniform intensity. In this manner each of the ribbons 204 (see FIG. 2) is evenly illuminated. As may be further observed, the spatial intensity distribution 212 of the line image 208 along the X-axis comprises a non-uniform distribution. In an embodiment of the present disclosure, the spatial intensity distribution 212 of the line image 208 along the X-axis comprises a Gaussian distribution. As previously discussed, the use of a non-uniform distribution along the X-axis allows a line image formed from light modulated by the light modulation device 200 to be more precisely focused in the X-direction.

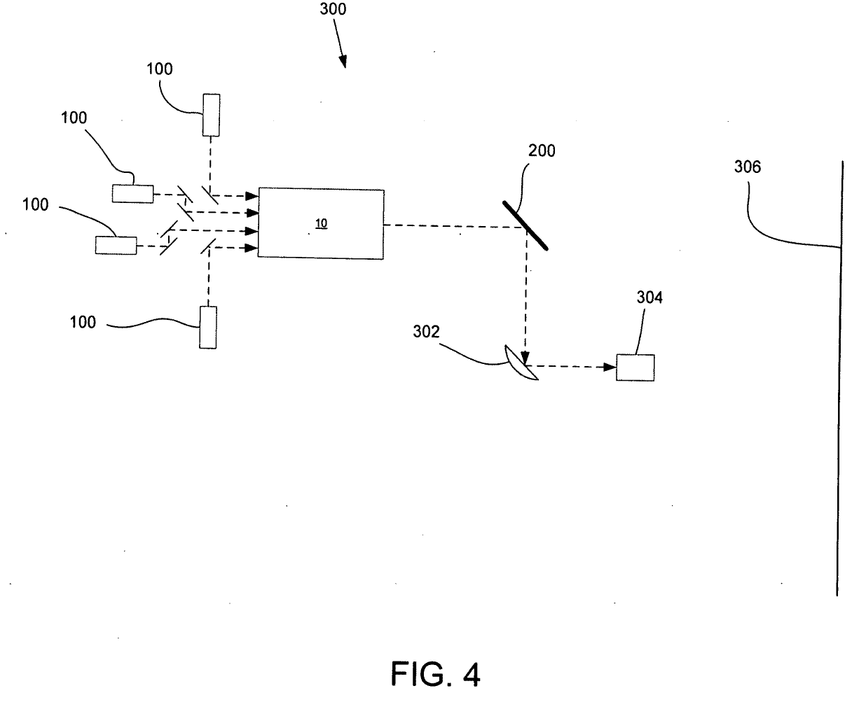

The optical system 10 shown in FIG. 1 and the light modulation device 200 shown in FIG. 2 may be part of a display system 300 as shown in FIG. 4. An optical assembly may direct beams of light, indicated by the dashed lines, from the plurality of light sources 100 into the optical system 10. A line image, such as the line image 208 shown in FIGS. 2 and 3, exiting the system 10 is directed onto the light modulation device 200. The line image may include a uniform distribution along a first axis and a non-uniform distribution along a second axis. A modulated line image is directed from the light modulation device 200 to a scanning mirror 302 and a projection lens 304 such that the display system 300 may employ a line-scan architecture for scanning an image onto a viewing surface 306.

It will be appreciated that the use of a light tunnel, with two open or non-light interactive sides, as described herein, e.g., light tunnel 103 represented in FIGS. 1 and 5A-5C, also provides another benefit relating to the polarization of the light. In particular, the use of a four-sided light tunnel, i.e., a tunnel whose four-side walls all interact with a light beam, fails to maintain the polarization of the light passing through it. For example, when a light tunnel with four (4) reflective sides is used by a LCOS-based projector, additional optical devices are utilized in an attempt to restore the linear polarization lost through the use of the four-sided light tunnel. Thus, an unexpected result to the use of a light tunnel with only two light reflective sides as described herein is that it may maintain the linear polarization of the incoming light beams.

Those having ordinary skill in the relevant art will appreciate the advantages provided by the features of the present disclosure. For example, it is a feature of the present disclosure to provide a system for converting the non-uniform distribution from a plurality of laser beams into a uniform distribution along a first axis of each of the laser beams and a non-uniform distribution along a second axis of the laser beams. Another feature of the present disclosure is a display system that is able to utilize multiple semiconductor lasers as a light source for a one-dimensional light modulator, such that light from each laser will uniformly illuminate an array of light modulating structures.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An illumination apparatus comprising:
at least one laser light source, the at least one laser light source emitting a laser light beam having a non-uniform distribution along a first axis and a second axis; and
a light tunnel, said light tunnel transforming the non-uniform distribution along the first axis of the laser light beam into a substantially uniform distribution while maintaining the non-uniform distribution along the second axis of the laser light beam.

2. The illumination apparatus of claim 1, wherein said first axis and said second axis are orthogonal with respect to each other.

3. The illumination apparatus of claim 1, wherein said light tunnel consists of only two internally reflective sides.

4. The illumination apparatus of claim 3, wherein said light tunnel further comprises a light entrance, a light exit, and two non-light interacting sides, wherein said two non-light interacting sides extend from the light entrance to the light exit of the light tunnel.

5. The illumination apparatus of claim 3, wherein said light tunnel further comprises a light entrance, a light exit, and two reflective sides, wherein said two reflective sides extend from the light entrance to the light exit.

6. The illumination apparatus of claim 1, wherein said at least one light source comprises a plurality of light sources.

7. The illumination apparatus of claim 1, wherein said at least one light source is a diode laser.

8. The illumination apparatus of claim 1, wherein the non-uniform distribution of the laser light beam along the second axis after exiting the light tunnel is a Gaussian distribution.

9. The illumination apparatus of claim 1, further comprising an optical device for increasing a divergence of the laser light beam emitted by each of the at least one laser light source.

10. The illumination device of claim 1, further comprising a light modulation device, said light modulation device modulating the laser light beam along the substantially uniform distribution of the first axis.

11. The illumination device of claim 10, wherein the light modulation device includes a one-dimensional array of micro-electro-mechanical elements for modulating light.

12. The illumination device of claim 11, wherein the micro-electro-mechanical elements comprise at least one of ribbons and cantilevers.

13. The illumination device of claim 10, wherein the light modulation device modulates light using at least one of polarization and diffraction.

14. The illumination device of claim 10, further compromising a scanning mirror for scanning light modulated by the light modulation device.

15. An apparatus for illuminating a surface with light from at least one laser light source, said light having a non-uniform distribution along a first axis and a second axis, said apparatus comprising:
a light mixing device having a light entrance and a light exit, two internally reflective sides that interact with the light and two sides that do not interact with the light;
wherein said light mixing device transforms the non-uniform distribution along the first axis of the light into a substantially uniform distribution while maintaining the non-uniform distribution along the second axis of the light.

16. The apparatus of claim 15, wherein said light mixing device is a light tunnel.

17. The apparatus of claim 15, wherein the two sides that do not interact with the light are open.

18. The apparatus of claim 15, further comprising an optical device for increasing a divergence of the light.

19. The apparatus of claim 15, further comprising an optical assembly for telecentrically focusing light exiting the light mixing apparatus onto the surface.

20. The apparatus of claim 15, wherein said light mixing apparatus preserves a polarization state of the light.

21. The apparatus of claim 15, wherein said two internally reflective sides that interact with the light and the two sides that do not interact with the light extend from the light entrance to the light exit.

22. The apparatus of claim 15, wherein said two internally reflective sides interact only with light in the first axis.

23. A display system for displaying a two-dimensional image on a surface, comprising:
a plurality of light sources, each of the plurality of light sources emitting a laser light beam having a non-uniform distribution along a first axis and a second axis, the laser light beams collectively defining an object;
an optical assembly for reducing a size of the object formed by the laser light beams and for increasing a divergence of the laser light beams;
a light tunnel for transforming the non-uniform distribution along the first axis of each of the laser light beams into a substantially uniform distribution while maintaining the non-uniform distribution along the second axis each of the laser light beams; and
a light modulation device, said light-modulation device operable to modulate each of the laser light beams along the substantially uniform distribution of the first axis.

24. The display system of claim 23, wherein said light tunnel comprises a light entrance, a light exit, two internally reflective sides extending from the light entrance to the light exit that interact with the laser light beams and two sides extending from the light entrance to the light exit that do not interact with the laser light beams.

25. The display system of claim 24, wherein the two sides that do not interact with the laser light beams are open.

26. The display system of claim 23, further comprising a scanning mirror for scanning modulated light.

27. The display system of claim 23, further comprising an optical device for focusing light exiting the light tunnel onto the light-modulating device.

28. The display system of claim 23, wherein the optical assembly reduces the size of the object between about 5 and about 50 times.

29. The display system of claim 23, wherein the optical assembly reduces the size of the object between about 18 and about 22 times.

30. The display system of claim 23, wherein the optical assembly reduces the size of the object by approximately 20 times.

31. The display system of claim 23, wherein the light-modulating device comprises a one-dimensional array of micro-electro-mechanical elements.

32. The display system of claim 31, wherein the micro-electro-mechanical elements comprise at least one of ribbons and cantilevers.

33. The display system of claim 31, wherein the micro-electro-mechanical elements modulate light using at least one of diffraction and polarization.

34. A method of illuminating a surface with a plurality of laser light beams, each of said laser light beams having a non-uniform distribution along a first axis and a second axis:
increasing a divergence of each of a plurality of laser light beams;
directing the laser light beams with the increased divergence into a light tunnel; and
imaging the laser light beams exiting the light tunnel onto the surface to thereby form a line image having a substantially uniform distribution along a first axis and a non-uniform distribution along a second axis.

35. The method of claim 34, further comprising the step of modulating the light beams exiting the light tunnel.

36. The method of claim 34, wherein said surface is a light modulating surface.

37. The method of claim 36, wherein said light modulating surface comprises a one-dimensional array of micro-electro-mechanical elements.

38. The method of claim 35, further comprising the step of scanning the modulated laser light beams onto a viewing surface.

39. The method of claim 34, wherein the light tunnel consists of only two internally reflective sides.

40. The method of claim 39, wherein the light tunnel further comprises two non-light interacting sides.

41. The method of claim 34, wherein the non-uniform distribution along the second axis of the image is a Gaussian distribution.
